(19) United States
(12) Patent Application Publication
(10) Pub. No.: US 2014/0377032 A1
(43) Pub. Date: Dec. 25, 2014

(54) LOCK WASHER WITH TWO RINGS OF TEETH

(71) Applicant: Christophe Delcher, Fraisses (FR)

(72) Inventor: Christophe Delcher, Fraisses (FR)

(21) Appl. No.: 14/344,348

(22) PCT Filed: Sep. 6, 2012
(86) PCT No.: PCT/FR2012/051993

§ 371 Date: Mar. 12, 2014

(30) Foreign Application Priority Data
Sep. 13, 2011 (FR) 1158141

(51) Int. Cl. F16B 39/28

(52) U.S. Cl. CPC F16B 39/28
USPC 411/149

(57) ABSTRACT

The invention relates to a locking washer (39) comprising two washer crowns (10, 26) having each an engagement face (11, 11′), the engagement face having a plurality of asymmetrical, radial teeth (16, 16′), each of the asymmetrical, radial teeth having, on the one hand, a crest (20, 20′) and a tooth bottom (18, 18′) separated angularly from the crest; and, on the other, a sliding side (22, 22′) which inclines and extends angularly between the crest (20,20′) and the tooth bottom (18, 18′), wherein the engagement faces (11, 11′) of the washer crowns are suitable for being applied against each other, whereas the sliding sides (22, 22′) come into contact with each other, respectively, along a contact surface. The engagement face (11′) of at least one of the washer crowns (26) has a recess (28) in order to reduce the contact surface of the sliding sides (22, 22′).

The present invention relates to a locking washer by which a screw/nut system can be maintained locked against rotation after it has been tightened

The known locking washers comprise two washer crowns applied coaxially against each other, and they are adapted to mesh between the bearing element and the nut. They each have an engagement face and an opposite ribbed bearing face. The engagement face as such has asymmetrical, radial teeth, and those asymmetrical, radial teeth have, on the one hand, a crest and a tooth bottom spaced angularly from the crest at an angle being, substantially, smaller than about 60°, and, on the other hand, two opposed sides. One of the sides is substantially inclined relative to the median plane defined by the washer crown, and it extends angularly between the crest and the tooth bottom. It is intended to form a sliding side. The angle with the greatest slope of the sides substantially inclined relative to the median plane should be substantially superior to the helix angle of the screw/nut system. The other side is substantially perpendicular to the inclined side of the following tooth, and it constitutes a stop side. Thus, the engagement faces of the washer crowns are intended for being applied against each other, such that, on the one hand, the inclined sliding sides come into contact with each other, respectively, and, on the other hand, the stop sides come into abutment with each other, respectively.

Also, when the nut is screwed, the locking washer is held in a vise-grip between the bearing element and the nut, and the engagement faces are brought along axially towards each other under pressure. In turn, when the nut tends to loosen, it brings along the washer crown against which it bears in rotation, and consequently the sliding sides of that washer crown are brought along slidingly against the sliding sides of the other washer crown, while forming a ramp. In this manner, the washer crowns are separated axially from each other according to a modulus which is higher than that of the translation movement of the nut relative to the screw. Consequently, the axial tension which is exercised in the screw/nut system increases significantly. Due to that, the friction forces generated in the screw/nut system increase considerably and bring about the locking of the nut against rotation. More specifically, since the sliding side is inclined relative to the axis of the screw/nut system at an angle greater than that of the helix angle of the system, at the moment when the nut brings the washer crown into rotation when it loosens, the latter is brought along axially against it, and locks it by wedge effect.

This type of washer which is described in particular in EP 0131556 is, however, associated with certain drawbacks. Actually it is effective inasmuch as the washer crown meshes with the nut when it loosens and that applies in all circumstances. This is why the bearing faces opposite the engagement faces of the crowns are provided with ribs to enable them to come to engage respectively in the screw and in the bearing element.

However, by coming into engagement with the bearing elements, the ribs cause imprints to be formed thereon which deteriorates the state of the surface thereof.

Also, a problem that arises and which the present invention is aimed at solving is to provide a locking washer with two washer crowns which does not deteriorate the state of the surface of the bearing element.

To this end, the present invention proposes a locking washer intended for being compressed axially between a bearing element and a screwable element, the screwable element being connected to the bearing element by a shank member suitable for traversing the locking washer, wherein the locking washer comprises two washer crowns having each an engagement face, which engagement face has a plurality of asymmetrical, radial teeth, each of the asymmetrical, radial teeth having, on the one hand, a crest and a tooth bottom spaced angularly from the crest, and, on the other hand, a sliding side which is inclined and extends angularly between the crest and the tooth bottom, wherein the engagement faces of the washer crowns are suitable for being applied against each other, whereas the sliding sides come into contact with each other, respectively, along a contact surface, the washer crowns being suitable for meshing with the screwable element and the bearing element, respectively, when the screwable element loosens, so that the washer crowns are caused to rotate relative to each other, whereas the respective sides are brought along slidingly against each other, respectively, while forming a ramp, to separate the washer crowns axially from each other to bring about the locking against rotation of the screwable element. According to the invention, the engagement face of at least one of the washer crowns has a recess to reduce the contact surface of the sliding sides, whereby the sliding action of the sliding faces against each other diminishes.

Thus, it is a characteristic feature of the invention to provide a recess in one of the engagement faces in order to reduce the contact surface between the two engagement faces of the two washer crowns, and more specifically between the sliding sides. In this way, the modulus of the friction forces that resist the relative movement of the two washer crowns is reduced, whereas the modulus of those friction forces that oppose, on the one hand, the relative movement of the one of the washer crowns relative to the screwable element, and, on the other, the other one of the washer crowns relative to the bearing element, remains the same. Thus, the recess in the engagement face favours the respective sliding of the sides of the washer crowns against each other, and consequently the relative translation movement of the washer crowns which brings about the locking effect. There is consequently no need whatsoever to provide ribs in the bearing faces and, consequently, the state of the surfaces of the bearing elements is maintained

According to a particularly advantageous embodiment of the invention, the engagement face has a circular groove forming the recess. Thus, when the circular groove is centred on the axis of the washer crown, the tangents to the protruding edges of the circular groove are perpendicular to the radii of the washer crowns, and thus, when the washer crowns are brought along in movement relative to each other, the protruding edges are brought along in movement at right angles to the radii. In this way, the torque of the friction forces is substantially constant, no matter the angular position of the washer crowns relative to each other. Actually, no matter the surface state of the engagement faces, the protruding edges being, in every point, in parallel with the movement, they do not interfere with the resistance of the two washer crowns to move into rotation relative to each other.

Besides, the circular groove extends axially in a depth which is larger than or equal to the distance by which the tooth bottom and the crest, respectively, are separated. Thus, at right angles to the groove, there is no contact between the two engagement faces of the two respective washer crowns. Those two engagement faces are in contact with each side of the groove, towards the exterior and towards the interior.

Particularly advantageously, the at least one of the washer crowns having an interior edge opposite an exterior edge, the circular groove extends substantially in parallel with the edges. Thus, the circular groove is provided coaxially in the washer crown. In this way, the contact surfaces of the engagement faces, to each side of the groove, remain identical during the relative movement of the two washer crowns.

According to a particularly advantageous alternative embodiment of the invention, the circular groove extends radially across a distance which is larger than one quarter of the radial distance that extends between the exterior and interior edges. In this way, one obtains a very sensitive variation of the friction forces between the two crowns of the washer according to the invention compared to two crowns without grooves.

Besides, preferably the circular groove extends close to the exterior edge of the washer crown in order to diminish the friction forces that appear between the two washer crowns most distally from their axis of rotation. Actually, for a given contact surface, the farther away it is from the axis of rotation, the higher the resistive torque.

Besides, each of the asymmetrical, radial teeth has a stop side opposite the sliding side relative to the crest. This stop side, which has a very slight inclination relative to an axial plane of the locking washer, allows the radial teeth of the two crowns to mesh with each other, stop sides against stop sides, when the screwable element is tightened.

According to a further, particularly advantageous alternative embodiment of the invention, the locking washer has a tapered shape, and the locking washer is elastically deformable to be able to be deformed until flattened, while forming a spring between the bearing element and the screwable element. In this manner, when the two crowns are deformed to a flattened state between the bearing element and the screwable element, they exert a respective axial pressure against the bearing element and against the screwable element. When, for any reason whatsoever, the nut separates axially from the bearing element, the two crowns will then, by spring effect, have a tendency to revert to their initial conical shape and will continue to exercise, respectively, the axial pressure against the screw and the bearing element. Consequently, when the nut tends to loosen in this position, separated from the bearing element, the washer crowns stay in rotational mesh with the nut and the bearing element, respectively. Also, they are brought along in rotation relative to each other, and the locking effect is generated. According to this alternative embodiment, the crowns are preferably made from a spring steel.

Other characteristic features and advantages of the invention will become apparent by reading of the following description of particular embodiments of the invention, given as non-limiting illustration, with reference to the accompanying drawing, wherein:

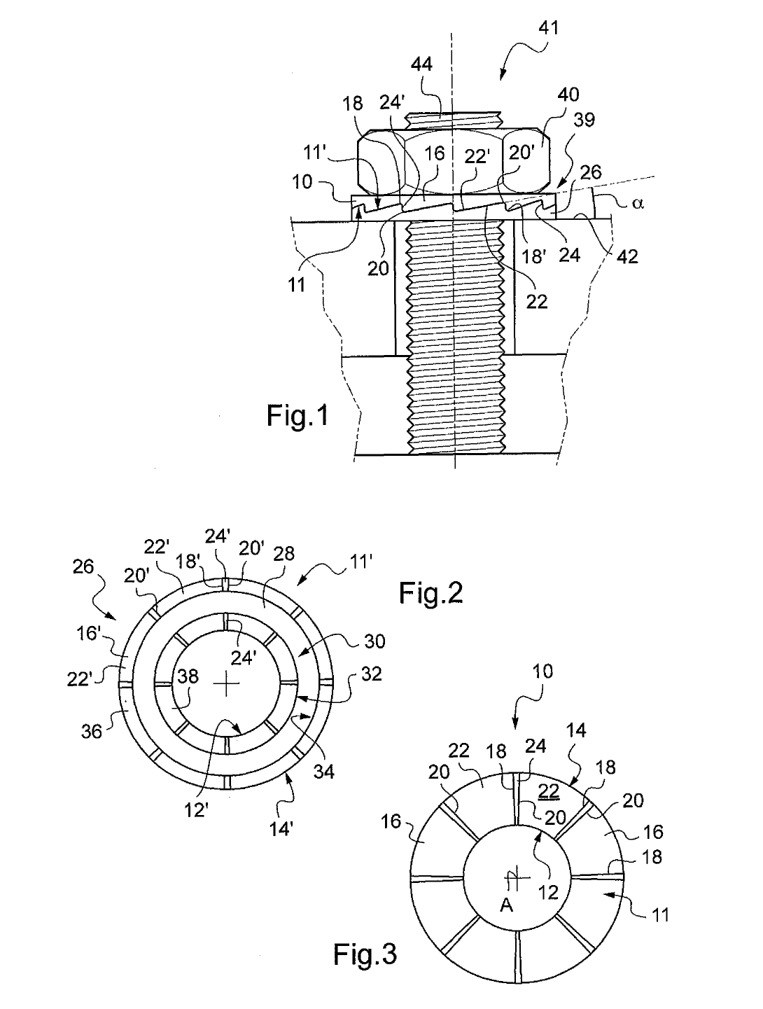

FIG. 1 is a schematic view of a screwable element including a locking washer according to the invention;

FIG. 2 is a schematic view, seen from in front, of one of the elements of the locking washer shown in FIG. 1;

FIG. 3 is a schematic view, seen from in front, showing the other one of the elements of the locking washer shown in FIG. 1;

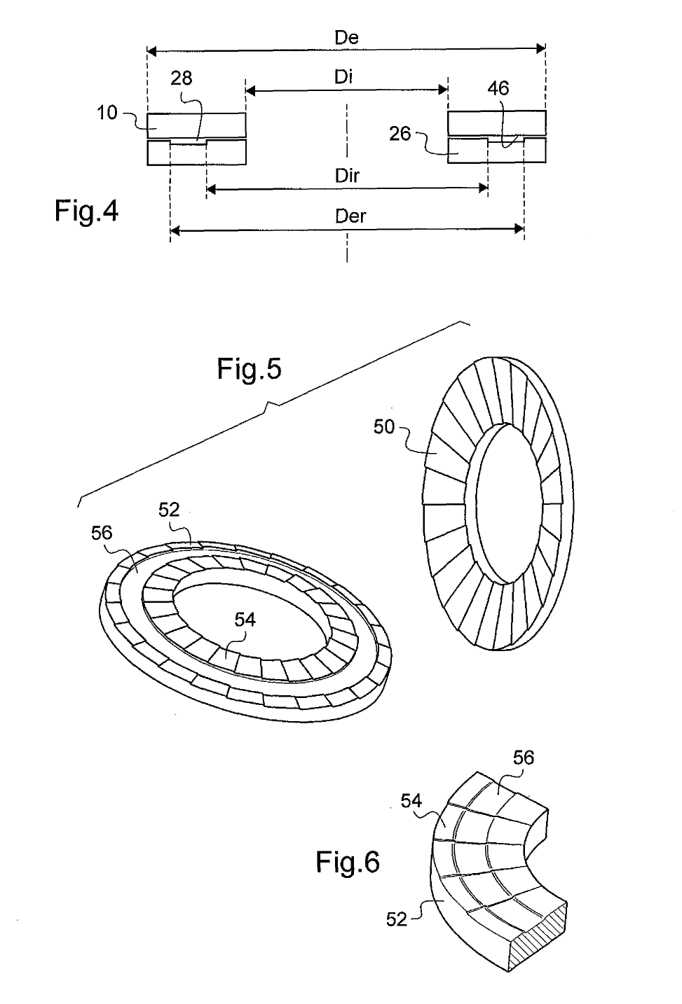

FIG. 4 is a schematic view, seen in an axial sectional view, of the two mating elements shown in FIGS. 2 and 3, respectively;

FIG. 5 is a schematic perspective view of two elements of a locking washer according to the invention, according to a further embodiment, and

FIG. 6 is a schematic, perspective view of a segment of the one of the two elements shown in FIG. 5.

Reference is first made to FIG. 3 which shows an engagement face 11 of a first washer crown 10. It has an interior edge 12 opposite an exterior edge 14, and eight identical, asymmetrical, radial teeth 16 that are uniformly distributed along the periphery of the first washer crown 10. Obviously, herein, the number of teeth is nowhere limiting, but is set forth for illustrative purposes only. Actually, it is possible to configure the washer crowns with sixteen, twenty or even twenty-two teeth. Each of the radial teeth 16 has a crest 20 and a tooth bottom 18, and to each side of their crest 20 they have a sliding side 22 and a stop side 24. The sliding side 22 is substantially inclined relative to the median plane of the first washer crown 10, which is in parallel with the plane of the drawing, and it extends angularly for each of the teeth 16 in the figure in the clockwise direction, between the crest 20 and the bottom 18, across an angular section close to π/4. As regards the stop side 24, it is substantially inclined relative to the axis A of the first washer crown 10, and it extends, for each of the teeth 16, in the counter-clockwise direction, between the crest 20 and the tooth bottom 18 of the following tooth 16.

FIG. 2, to which reference is now made, shows a second crown 26, whose engagement face 11′ is identical to that of the first washer crown 10, except that it has, precisely on the engagement face 11′ thereof, a circular groove 28 forming a recess. The other elements of the second washer 26 are analogous to those of the first washer crown 10, and they are indicated by the same references provided with the prime symbol >>′<<. Thus, the circular groove 28, which has a groove bottom 30 and two opposed groove edges 32, 34 extends radially between the interior edge 12′ and the exterior edge 14′ of the second crown 26. The groove bottom 30 is substantially in parallel with the median plane of the second washer crown 26, and their depth is sufficiently large for the tooth bottoms 18′ to be truncated. In other words, the circular groove 28 extends axially in a depth which is larger than or equal to the distance that separates the tooth bottom 18′ from the crest 20′. In this way, the groove 28 divides each of the sliding sides 22′ into two circular boundaries, an exterior, circular boundary 36 and an interior, circular boundary 38.

It will appear that the groove 28 extends close to the exterior edge 14′ of the second washer crown 26 in such a way as to provide an interior, circular boundary 38 which is larger than the exterior, circular boundary 36. In the description that follows, it will be explained why such arrangement is of interest. Besides, the width of the groove 28 is materially equivalent to one third of the radial distance that extends between the exterior edge 14′ and the interior edge 12′.

The first and the second crown 10, 26 have identical engagement faces 11, 11′, and they will be capable of being applied against each other in order to cooperate.

FIG. 1 illustrates a screwed assembly 41. Herein, the first 10 and the second 26 washer crowns are once again shown, engagement face 11 against engagement face 11′, while forming a locking washer 39 in mesh between a nut 40 and a bearing element 42, and also traversed by a threaded shank member 44.

Also, the crests 20 of the radial teeth 16 of the first crown 10 are lodged in the tooth bottoms 18′ of the radial teeth 16′ of the second crown 26 and vice versa, while, on the one hand, the sliding sides 22 of the first washer crown 10 are in contact with the sliding sides 22′ of the second washer crown 26, and, on the other, the stop sides 24 of the first crown 10 are in contact with the stop sides 24′ of the second washer crown 26. This adjustment of the washer crowns 10, 26, and more specifically of the engagement faces 11, 11′, the one into the other, has been obtained when the nut 40 has been screwed onto the threaded shank member 44, in the clockwise direction, seen from above, to sandwich in the two washer crowns 10, 26 with the bearing element 42. During tightening as such, the friction forces between the nut 40 and the first crown 10 have provoked the rotation of the latter in the same direction, whereas, oppositely, the friction forces between the second crown and the bearing element 42 have offered a resistance to movement. Also the sliding sides 22, 22′ of the two washer crowns 10, 26 have been entrained, respectively, in a sliding movement against each other until such point when the stop sides 24, 24′ enter into respective abutment against each other.

In this way, the engagement surfaces 11, 11′, the two washer crowns 10, 26 are in perfect contact with each other, and the only space that remains between the two is that which corresponds to the circular groove 28 provided in the second crown 26 and which will be shown in a more detailed view in FIG. 4. Thus, due to the circular groove 28 provided in the second washer crown 26, a corresponding surface 46 in front of the engagement face 11 of the first washer crown 10 is free compared to the engagement face 11′ of the second crown 26.

Consequently, compared to a locking washer wherein the second washer crown 26 has no groove 28, the contact surface between the two engagement faces 11, 11′ is smaller herein, and consequently the friction forces that will be created during the relative movement of the two crowns 10, 26 will also be reduced. In the following will be shown, by means of an approximated calculation, the difference between a locking washer provided with a groove 28 and a locking washer that does not feature one.

The friction torque Cf between two washer crowns can be considered, in a first analysis, as being the product of the axial force F_{A} which induces the contact pressure between the engagement faces, and of the coefficient of friction to the interface p, the aggregate factor of the average friction radius rm. That is, put synthetically: Cf=F_{A}×μ×rm. This formula does not take into account the level of contact pressures, but merely the level of effort. However, it is valid to the extent that the contact pressure does not exceed the elastic or scuffing limits of the material. Also, the tribological properties of the material—which play no insignificant part—are not taken into account.

The average radius rm itself is expressed as being a third of the quotient of the difference between the exterior and the interior diameters of the washer crowns, in cube, and of the difference between the exterior and the interior diameters, in square. In the presence of the groove, it is right to subtract the corresponding part from each of the quotients, and thus, for the former, the difference between the external and the internal diameters, in cube, of the groove, and, for the latter, the difference between the external and internal diameters, in square.

Thus, according to an exemplary embodiment in which the interior and exterior diameters of the washer crowns 10, 26 are Di=11 mm and De=20 mm, and the internal and external diameters of the groove 28 are Dir=15 mm and Der=19 mm, while the coefficient of friction at the interface is 0.15 mm and the axial force F_{A} is 10 000 N, a friction torque Cf of 12 Nm is obtained for the washer crowns without groove, and a friction torque Cf of 11.1 Nm is obtained for the washer crown with groove.

The above results that are derived from a simplified calculation serve the sole purpose of illustrating the principle on which the invention relies. In return, it is indeed verified that by increasing the external diameter of the groove 28, and consequently diminishing the width of the exterior boundary 36, the friction torque is diminished even more.

Now, reference is once again made to FIG. 1 and the screwed assembly 41 to illustrate the advantages of the invention. Thus, when the nut 40 is brought along in rotation, seen from above, in the counter-clockwise direction, for instance in vibrating conditions, it has a propensity to loosen. Taking into consideration, on the one hand, the bearing pressure of the nut 40 against the bearing face of the first washer crown 10, opposite the engagement face 11, and, on the other, the bearing pressure of the bearing face of the second washer crown 26, opposite the engagement face 11′, against the bearing element 42, the nut 40 is in mesh with the first washer crown 10, whereas the second crown 26 is in mesh with the bearing element 42. In turn, the two washer crowns 10, 26 will be brought along in rotation relative to each other, and this even more so when the coefficient of friction between the two is weak. Owing to the circular groove 28, this coefficient of friction is reduced, and the relative movement into rotation of the two washer crowns 10, 26 is favoured.

Besides, the sliding sides 22, 22′ have an angle of a greater slope a than that of the helix angle of the threaded shank member 44. The relative rotational movement of the two washer crowns 10, 26 will thus provoke their translation movement according to a first modulus in two opposite directions along the axial direction, and consequently an increase in the tension in the threaded shank member 44, since the translation movement of the nut 40 relative to the threaded member 44 as such is of a second modulus which is smaller than the first. Consequently, the loosening of the nut 40 is stopped.

According to another embodiment of the invention illustrated in FIGS. 5 and 6, the first 50 and the second 52 crowns of a locking washer are of tapered shape, and they have twenty-two radial teeth 54. Besides, the second crown 52 has a circular groove 56 which is also shown in a more detailed view in FIG. 6. The advantage obtained with such circular groove is, just like the preceding exemplary embodiment, a decrease in the coefficients of friction between the two washer crowns 50, 52 when the screwable element loosens.

In turn, the second washer crown 50 in engagement with the first washer crown 52, engagement face against engagement face and teeth in teeth, form together a locking washer of generally tapered shape suitable for deforming elastically. Actually, when the locking washer thus obtained meshes between a screwable element and a bearing element, as the tightening proceeds, the two washer crowns 50, 52 deform together until they are flattened. In this position of maximal tightening, the two flattened washer crowns 50, 52 induce a supplementary axial force between the screwable element and the bearing element. This supplementary force reciprocates on the friction forces between, on the one hand, the bearing element and the second washer crown 52 and, on the other, the screwable element and the first washer crown 50. In this way, they respectively remain more easily in mesh and, consequently, the rotation of the two crowns 50, 52 relative to each other is facilitated and brings about the locking against rotation of the screwable element.

According to yet an embodiment of the invention which is not shown, the first washer crown which features no groove has a smaller thickness than the second washer crown in order to thereby obtain a different and non-uniform distribution of the contact pressure. Actually, by this embodiment, the pressures on the exterior boundary of the washer crowns are weaker, and consequently the coefficient of friction between the washer crowns is also weaker.

1. A locking washer intended for being compressed axially between a bearing element and a screwable element, wherein the screwable element is connected to the bearing element by means of a shank member suitable for traversing the locking washer, wherein the locking washer comprises two washer crowns having each an engagement face, the engagement face having a plurality of asymmetrical, radial teeth, each of the asymmetrical, radial teeth having, on the one hand, a crest and a tooth bottom angularly separated from the crest, and, on the other hand, a sliding side which inclines and extends angularly between the crest and the tooth bottom, the engagement faces of the washer crowns being suitable for being applied against each other, whereas the sliding sides come into contact against each other, respectively, along a contact surface, the washer crowns being suitable for meshing with the screwable element and the bearing element, respectively, when the screwable element loosens, with a view to bringing the washer crowns into rotation relative to each other, whereas the sliding sides are brought along slidingly against each other, respectively, while forming a ramp, to separate the washer crowns axially from each other to bring about the locking against rotation of the screwable element;
wherein the engagement face of at least one of the washer crowns has a recess in order to reduce the contact surface of the sliding sides and the sliding forces of the sliding sides against each other diminish.

2. A locking washer according to claim 1, wherein the engagement face has a circular groove forming the recess.

3. A locking washer according to claim 2, wherein the circular groove extends axially in a depth larger than or equal to the distance that separates the tooth bottom from the crest.

4. A locking washer according to claim 2, wherein the at least one of the washer crowns has an interior edge opposite an exterior edge, the circular groove extending substantially in parallel with the edges.

5. A locking washer according to claim 4, wherein the circular groove extends radially across a distance which is larger than one quarter of the radial distance that extends between the exterior and the interior edges.

6. A locking washer according to claim 4, wherein the circular groove extends close to the exterior edge of the washer crown.

7. A locking washer according to claim 1, wherein each of the asymmetrical, radial teeth also has a stop side opposite the sliding side relative to the crest.

8. A locking washer according to claim 1, wherein it has a tapering shape; and in that the locking washer is elastically deformable in order to be able to be deformed until flattened, while forming a spring between the bearing element and the screwable element.

9. A locking washer according to claim 8, wherein the washer crowns are made from a spring steel.
